(19) United States
(12) Patent Application Publication
(10) Pub. No.: US 2006/0101121 A1
(43) Pub. Date: May 11, 2006

(54) Stamped email system deploying digital postage

(76) Inventor: Annette Senechalle, Grandview, TX (US)

Correspondence Address: ROBERT A. HUNTSMAN, 5465 EAST TERRA LINDA WAY, NAMPA, ID, 83687-1515, US

(21) Appl. No.: 10/985,792

(22) Filed: Nov. 10, 2004

(51) Int. Cl. G06F 15/16

(52) U.S. Cl. 709/206

(57) ABSTRACT

An email postal system and method for acquiring, attaching, authenticating, and managing digital postage for use in conjunction with electronic mail (email) messages. The preferred embodiment teaches the use of a postage database used in conjunction with a digital stamp generator capable of generating branded digital stamps on demand. Methodologies for deploying digital postage techniques with classical email systems lacking postage capabilities using either an embedded or discrete mail submission agent is disclosed. Systems and methods for branding and canceling digital stamps in an email environment is also disclosed. The present invention further teaches the use of stamp recipient unit counters (SRU's) as methodology for associating economic value with digital postage stamps. A system and method for providing a gateway for receiving and managing emails having digital postage stamps is also disclosed.

### BACKGROUND OF THE INVENTION

In the modern internet computing community, computer users are subjected to numerous unwanted, unsolicited email messages, generally broadcast to large numbers of email addresses. This kind of unwanted and unsolicited email is commonly referred to as “spam.” There are numerous systems available to manage spam but each has significant drawbacks.

U.S. Pat. No. 6,052,709, entitled “Apparatus and Method for Controlling Delivery of Unsolicited Electronic Mail” teaches a system where artificial addresses are delivered to decoy internet sites where electronic mass marketers (spammers) are likely to obtain their address information through a process informally known as harvesting. When the decoyed sites receive email, the decoy sites report to a central controller having a spam blocking system. Email clients can then use the database to help determine if incoming emails are spam by comparing content and headers with spam in the database. Such a system suffers from the fact that guesswork is required and only spam from spammers that have previously been attracted to the decoy sites will be detected. Additionally, under this system, some legitimate mail will likely get erroneously blocked.

U.S. Pat. No. 6,266,692 entitled “Method for Blocking All Unwanted E-mail Using a Header-Based Password” utilizes pass codes associated with the email addresses. Messages with incorrect pass codes are deleted. Messages without pass codes are held for a short period of time, until they are either approved for receipt or deliberately deleted. Various protocols for obtaining the pass codes are set forth. Such systems suffer from the limitation that suspected spam still must be managed individually. For example, such systems typically have the burden of managing quarantined email or requiring that each individual suspect email be manually examined for approval or rejection.

U.S. Pat. No. 6,249,805 entitled “Method and System for Filtering Unauthorized Electronic Mail Messages” utilizes a “junk mail” folder. All email from unauthorized, typically determined by looking at recipients address book, is automatically directed to the junk mail folder. Such systems suffer from the limitation that eventually, sorting of the junk mail folder is required, and many valid messages from first time senders and legitimate one time senders will unconditionally be blocked.

U.S. Pat. No. 6,161,130 screens messages with a “probabilistic classifier.” In this system, incoming suspected spam emails are content screened. Those messages having inappropriate content are automatically discarded. The probabilistic classifier is re-trained for improved spam email recognition. Such systems suffer from the limitation that the classifier is guesswork and does not, with certainty, properly distinguish legitimate email from spam.

Thus, all these systems all have their drawbacks. So-called “spam probe email addresses” are randomly placed and as a result of this random placement, are unfortunately random in their detecting suspected spam email. Moreover, so-called pass codes systems and junk mail folder systems all depend on imperfect screening criteria and require eventual sorting. So-called “automatic screening” can result in the deletion of desired email. What is needed is a system that eliminates virtually all unwanted spammed email messages.

### SUMMARY OF THE INVENTION

The present invention addresses and solves the limitations of the prior art by teaching a novel email system modeled after traditional postal mail systems. In the traditional postal mail service, the sender is required to obtain postage stamps and attach postage stamps to each outgoing mailed message. When deploying the present invention, the sender also is required to obtain sufficient postage in the form of one or more digital stamps and affix the postage to outgoing mail. However, the present invention deals with electronic email rather than physical mail, thus the systems for obtaining, affixing, authenticating, and canceling mail must be adapted to the computer and internet environment.

The present invention also differs from traditional email systems as well. Like traditional postal mail systems, but unlike traditional email systems, when deploying the present invention, a sender must obtain one or more digital stamps for each sent email thus eliminating mail from spammers whose business models require free outgoing mail to be economically viable.

The present invention envisions that generally digital stamps will be purchased, thus transferring an economic cost to the spammer. However, the present invention also anticipates systems where the digital stamps may not require explicit monetary payment. For example, the stamp vendors may provide free digital postage, but require stamp “purchasers” to authenticate themselves in some way, thus deterring spammers who require anonymity for their spamming schemes to work. Unlike traditional mail systems, the present invention deploys digital stamps that, unlike traditional stamps, are copied numerous times in the normal flow of mail traffic because of the nature of electronic messages, and thus must be managed and cancelled in a different way than traditional postage with a single physical postage stamp. The present invention teaches a novel way to process digital postage, including how to create, purchase, manage, attach, detect and cancel digital postage stamps.

In the preferred embodiment, the enhanced functionality is encapsulated in a mail submission agent daemon computer process on the client computer hosting the email client. Outgoing email is forwarded through the mail submission agent which determines if digital postage is necessary, and, if required, the mail submission agent will acquire and affix the digital postage before sending the outgoing email.

### DESCRIPTION OF THE SEVERAL VIEWS OF THE DRAWING

FIG. 1 illustrates generally the preferred embodiment of the invention including an associated digital stamp vendor.

FIG. 2 shows a more detailed view of the digital stamp processor of the present invention.

FIG. 3 shows another embodiment of the present invention illustrating encrypted stamp identifiers.

FIG. 4 shows a more detailed view of the postage-based email receiving agent of the present invention.

### DETAILED DESCRIPTION OF SEVERAL EMBODIMENTS

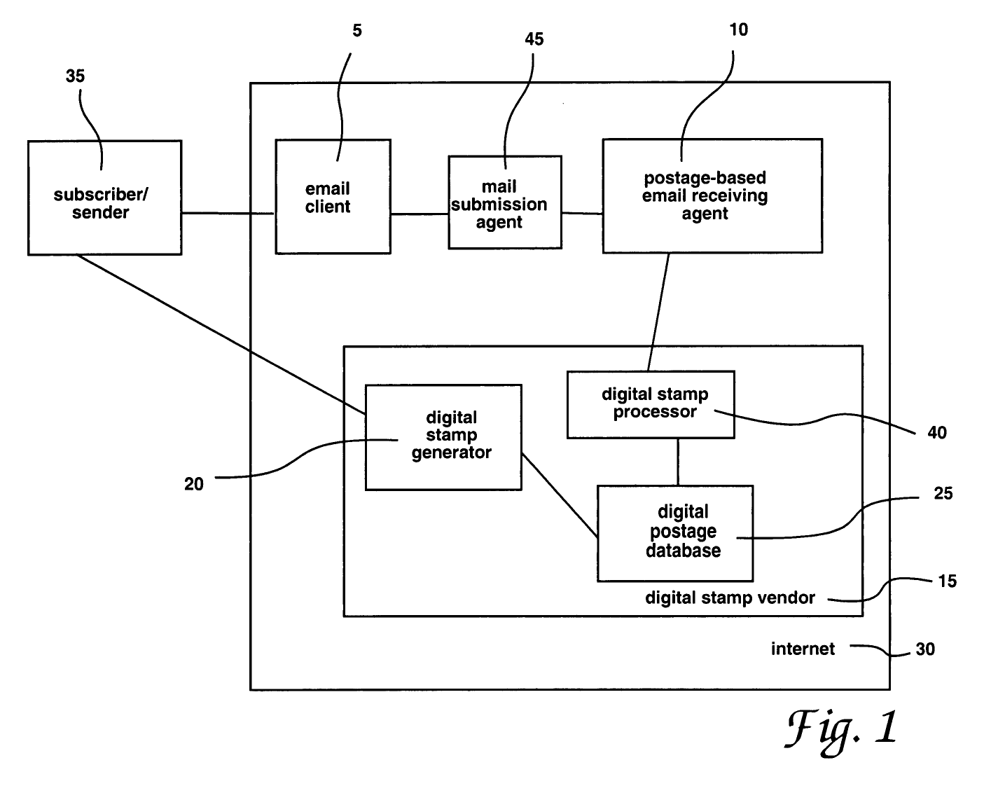

FIG. 1 shows the preferred embodiment of the present invention as realized on the internet. Referring to FIG. 1, FIG. 1 illustrates a subscriber/sender 35 having access to an email client 5 in the internet environment 30. When the subscriber/sender 35 chooses to send an email to a recipient deploying the present invention, the subscriber/sender 35 composes a message, typically using the email client 5. In the preferred embodiment, the email client 5 is interfaced to a mail submission agent 45 implemented as a daemon using a non standard SMTP port. When the message is sent from the email client, the SMTP protocol causes the message to be sent to the mail submission agent daemon 45 which resolves the target address of the email. By inspection of the target address, the mail submission agent 45 determines if digital postage is needed, acquires and affixes digital postage if needed, and transmits the message via the SMTP protocol to the target address. The target address identifies the receiver's postage-based email receiving agent 10. The postage-based email receiving agent 10 can receive mail from either a traditional email client or from a mail submission agent 45.

If a sender uses a traditional email client that has no knowledge of the receiver's requirement for a digital postage stamp, the email will be rejected, either directly wherein the email is returned to the sender, optionally with a message or error indicating a digital postage stamp is required. Alternatively, the receiver may store all messages lacking the appropriate digital postage stamp in a special list or archive, allowing the potential recipient to deploy a special tool (not shown) to inspect such messages manually.

In the event the subscriber/sender 35 is familiar with the digital postage stamp requirements of the present invention, the subscriber/sender 35 will engage with a digital stamp vendor 15, typically via an internet protocol, and purchase or otherwise acquire one or more digital stamps. The digital stamp vendor 25 can retrieve unused and thus unassigned digital stamps (as identified by a unique stamp identifier) from the digital postage database 25, and optionally deploy the digital stamp generator 20 as required to generate new digital stamps, each having a unique stamp identifier, to replenish the new stamp reservoir, or, alternatively, generate new digital stamps on demand. As each stamp is purchased, the identifier of the digital stamp, along with information identifying the subscriber/sender 35 and the status of the digital stamp (initially “unused”) are recorded in the digital postage database 25. In the preferred embodiment, the subscriber/sender 35 implicitly attaches the digital stamp to the email with the mail submission agent daemon 45. The digital stamp is attached to the outgoing email, typically as an attachment, a specialized header, or a combination of an attachment and specialized email header. The email is transmitted to the receiver's postage-based email receiving agent 10 using traditional internet mailing protocols. The receiver's postage-based email receiving agent 10 has an interface to each possible digital stamp vendor 15 and each vendor's 15 associated digital stamp processor 40 and digital postage database 25. The digital stamp processor 40 is responsible for determining if a given digital stamp is authentic and unexpired and optionally interfaces with the digital postage database 25, allowing the status of a particular stamp to be examined.

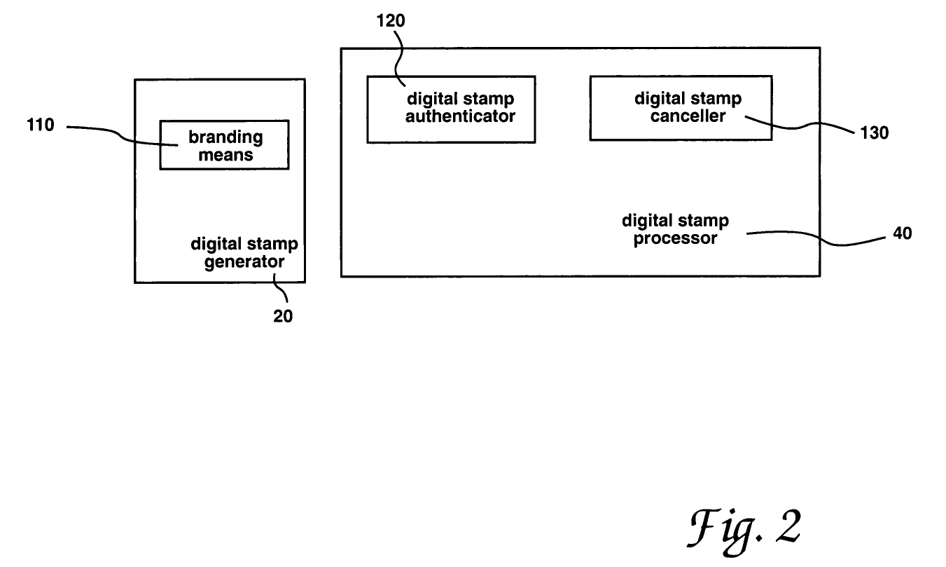

FIG. 2 shows the digital stamp generator 20 and the digital stamp processor 40 in slightly more detail. Referring to FIG. 2, the digital stamp generator 20 generally includes the ability to generate either a textual or graphic digital stamp, and furthermore includes some kind of branding means 110 to encode unique branding information that identifies the associated digital stamp vendor 15 and also brands a stamp as authentic. The digital stamp processor 40 includes a digital stamp authenticator 120 which authenticates a particular stamp. In the preferred embodiment, the digital stamp authenticator 120 is able to decode the brand invoked by the branding means 110, query the associated digital postage database 25 and determine if a particular digital stamp is both authentic and unused (uncancelled). The digital stamp canceller 130 of the digital stamp processor 40 cancels a given stamp on demand. In the preferred embodiment, a stamp is cancelled by changing the status of a stamp identified in the digital postage database 25 to “used/cancelled”.

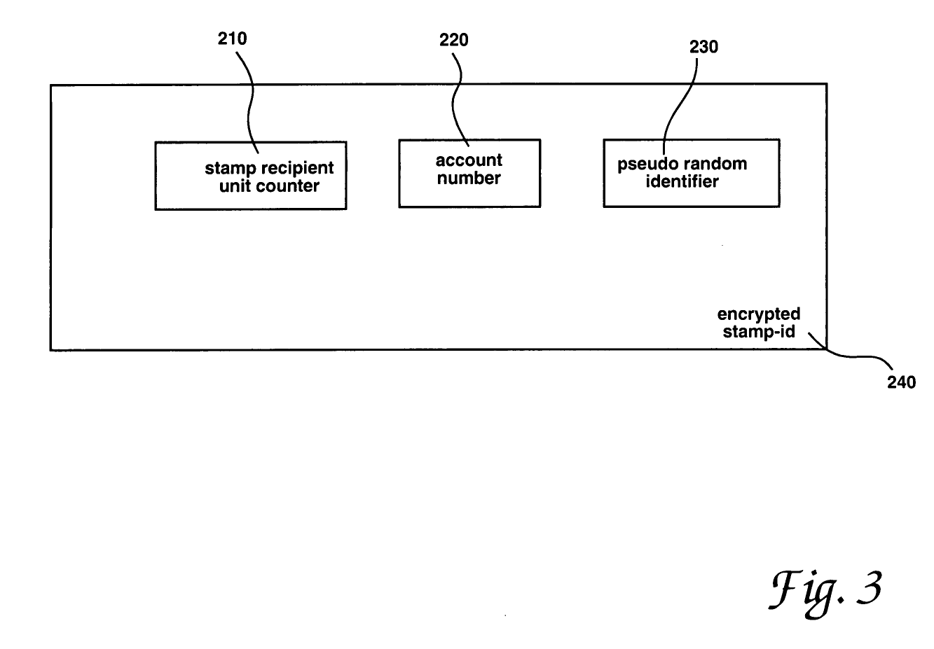

In the present invention, digital stamps are encoded with an encrypted stamp-id that serves as an identifier, uniquely identifies each digital stamp, and can be used to identify the status of a particular digital stamp in the digital postage database 25. FIG. 3 shows a more detailed view of an encrypted stamp-id 240. Referring to FIG. 3, and encrypted stamp-id 240 of the preferred embodiment includes a stamp recipient unit counter 210 that identifies the value of a stamp. In the preferred embodiment a stamp recipient unit counter 210 (hereafter “SRU”) having a value of 1 indicates sufficient postage to deliver a single message to a single recipient; a value of 3 would indicate sufficient postage to send a single message to three recipients. In general, the SRU indicates the economic value of the stamp in a linear fashion such that doubling the value of the SRU doubles the economic value of the digital stamp. The encrypted stamp-id 240 further includes an account number 220 that identifies the associated purchaser, and a pseudo random identifier 230 to assist in hiding the account number from casual inspection.

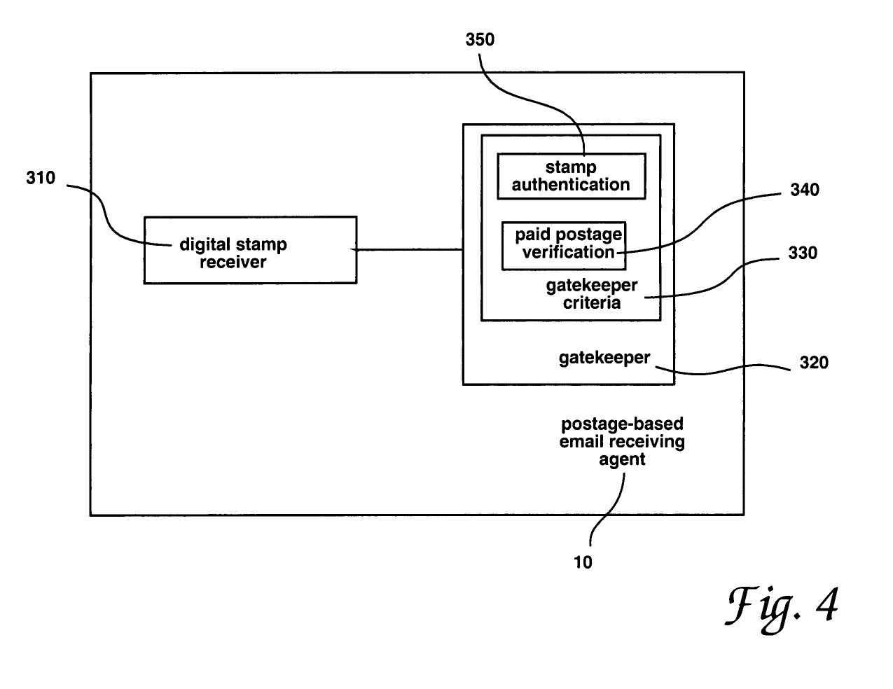

FIG. 4 shows a more detailed view of the postage-based email receiving agent 10. Referring to FIG. 4, the postage based email agent 10 further includes a digital stamp receiver 310 and a gatekeeper 320. The gatekeeper 320 determines the final disposition of each received email. The gatekeeper 320 utilizes gatekeeper criteria 330 which generally includes stamp authentication 350 and postage verification 340, ensuring that sufficient and valid postage is supplied for a particular email before it is delivered to a recipient accepting only paid email.

The figures and associated description of the preferred and other embodiments are provided for the purposes of illustration, not limitation. The claimed invention is applicable in a number of environments not specifically described. The invention should only be limited by the claims as set forth below.

I claim:

1. A system for sending email from a subscriber having an email client in a networked mail environment, the email client configured to affix at least one digital postage stamp to outgoing email messages comprising:
a digital postage database,
a digital stamp generator, wherein the digital stamp generator is capable of creating digital postage stamps,
a postage-based email receiving agent,
wherein the subscriber obtains digital postage in the form of at least one digital postage stamp, deploys the email client to compose an outgoing email message and affix the digital postage, transmits the email to the postage-based email receiving agent, wherein the postage-based email receiving agent tests the digital postage for validity,
wherein email having valid and sufficient digital postage is further transmitted to the intended recipient,
wherein email lacking valid and sufficient digital postage is rejected.

2. A method for sending email from a subscriber having an email client in a networked mail environment, the email client configured to affix at least one digital postage stamp to outgoing email messages comprising the steps of:
associating a digital postage database with the networked mail environment,
associating a digital stamp generator with the networked mail environment, wherein the digital stamp generator is capable of creating digital postage stamps,
associating a postage-based email receiving agent with the networked mail environment,
wherein the subscriber obtains digital postage in the form of at least one digital postage stamp, deploys the email client to compose an outgoing email message and affix the digital postage, transmits the email to the postage-based email receiving agent, wherein the postage-based email receiving agent tests the digital postage for validity,
wherein email having valid and sufficient digital postage is further transmitted to the intended recipient,
wherein email lacking valid and sufficient digital postage is rejected.

3. A system for deploying digital postage stamps in a networked mail environment comprising:
a digital stamp renderer, the renderer further including a branding means, wherein the branding means encodes branding information in each rendered digital stamp,
a digital stamp authenticator,
a digital stamp canceller,
wherein the branding information encoded in at least one digital stamp is tested for authentication and digital stamps are authenticated and canceled after use
wherein multiple and unauthorized digital stamp use is disallowed.

4. A method for deploying digital postage stamps in a networked mail environment comprising the steps of:
associating a digital stamp renderer, the renderer further including a branding means with the networked mail environment, wherein the branding means encodes branding information in each rendered digital stamp,
associating a digital stamp authenticator with the networked mail environment,
associating a digital stamp canceller with the networked mail environment,
wherein the branding information encoded in at least one digital stamp is tested for authentication and digital stamps are authenticated and canceled after use wherein multiple and unauthorized digital stamp use is disallowed.

5. A system for creating digital postage for use with an electronic mail message, comprising:
an encrypted stamp-id, the encrypted stamp-id further includes:
a stamp recipient unit counter,
an account number, wherein the account number identifies the purchaser, and
a unique pseudo-randomly generated identifier.

6. The system of claim 5 wherein the value of the stamp recipient unit counter indicates the value of the associated digital postage.

7. The system of claim 5 wherein the value of the stamp recipient unit counter indicates the maximum number of recipients that may receive the associated message.

8. The system of claim 6 wherein the value of the stamp recipient unit counter indicates the maximum number of recipients that may receive the associated message.

9. A method for creating digital postage for use with an electronic mail message, comprising the steps of:
associating an encrypted stamp-id with networked mail environment, the encrypted stamp-id further includes:
a stamp recipient unit counter,
an account number, wherein the account number identifies the purchaser, and
a unique pseudo-randomly generated identifier.

10. The method of claim 9 wherein the value of the stamp recipient unit counter indicates the value of the associated digital postage.

11. The method of claim 9 wherein the value of the stamp recipient unit counter indicates the maximum number of recipients that may receive the associated message.

12. The method of claim 10 wherein the value of the stamp recipient unit counter indicates the maximum number of recipients that may receive the associated message.

13. A system for receiving and delivering incoming email to at least one potential email recipient in a network mail environment, the email having a digital stamp, the digital stamp having an associated postage amount comprising:
a mail receiver server, wherein the server further includes:
a digital stamp receiver,
a gatekeeper, the gatekeeper having associated criteria, wherein incoming mail meeting the criteria is delivered to the recipient and incoming mail failing to meet the criteria is rejected, the criteria includes:
authenticating each digital stamp, verifying the purchaser associated with the account number is the stamp purchaser,
verifying the postage amount associated with all attached digital stamps equals or exceeds a predetermined amount.

14. The system of claim 13 wherein the digital stamp is an encrypted field in the stamp-id header.

15. The system of claim 13 wherein the digital stamp is an attached file.

16. The system of claim 13 wherein the mail receiver server is an SMTP mail server.

17. The system of claim 14 wherein the mail receiver server is an SMTP mail server.

18. A method for receiving and delivering incoming email to at least one potential email recipient in a network mail environment, the email having a digital stamp, the digital stamp having an associated postage amount comprising the steps of:
associating a mail receiver server with the networked mail environment, wherein the server further includes:
a digital stamp receiver,
a gatekeeper, the gatekeeper having associated criteria, wherein incoming mail meeting the criteria is delivered to the recipient and incoming mail failing to meet the criteria is rejected, the criteria includes:
authenticating each digital stamp, verifying the purchaser associated with the account number is the stamp purchaser,
verifying the postage amount associated with all attached digital stamps equals or exceeds a predetermined amount.

19. The method of claim 18 wherein the digital stamp is an encrypted field in the stamp-id header.

20. The method of claim 18 wherein the digital stamp is an attached file.

21. The method of claim 18 wherein the mail receiver server is an SMTP mail server.

22. The method of claim 19 wherein the mail receiver server is an SMTP mail server.

23. A system for attaching digital postage to an outgoing email for transmission by a well known email client on an email client computer in a networked mail environment comprising:
a mail submission agent,
wherein the email client is interfaced with the mail submission agent, the email client is configured to send outgoing email through the mail submission agent, wherein the mail submission agent optionally applies digital postage to outgoing emails received from the email client.

24. The system of claim 23 wherein the targeted address of each outgoing email is tested to determine if the targeted address is associated with a stamped email system, if the targeted address is associated with a stamped email system then the mail submission agent obtains and attaches the appropriate digital postage stamps to the outgoing email, and transmits the outgoing email to the targeted address, otherwise, the outgoing email is sent to the targeted address without digital postage.

25. The system of claim 23 wherein the mail submission agent is configured to receive email from the well known email client on a specified TCP/IP port.

26. The system of claim 23 wherein the mail submission agent is a daemon on the email client computer.

27. The system of claim 23 wherein the mail submission agent is embedded in the email client.

28. The system of claim 24 wherein the mail submission agent is configured to receive email from the well known email client on a specified TCP/IP port.

29. The system of claim 24 wherein the mail submission agent is a daemon on the email client computer.

30. The system of claim 24 wherein the mail submission agent is embedded in the email client.

31. The system of claim 28 wherein the mail submission agent is a daemon on the email client computer.

32. The system of claim 28 wherein the mail submission agent is embedded in the email client.

33. A method for attaching digital postage to an outgoing email for transmission by a well known email client on an email client computer in a networked mail environment comprising the steps of:
associating a mail submission agent with the networked mail environment,
wherein the email client is interfaced with the mail submission agent, the email client is configured to send outgoing email through the mail submission agent, wherein the mail submission agent optionally applies digital postage to outgoing emails received from the email client.

34. The method of claim 33 wherein the targeted address of each outgoing email is tested to determine if the targeted address is associated with a stamped email system, if the targeted address is associated with a stamped email system then the mail submission agent obtains and attaches the appropriate digital postage stamps to the outgoing email, and transmits the outgoing email to the targeted address, otherwise, the outgoing email is sent to the targeted address without digital postage.

35. The method of claim 33 wherein the mail submission agent is configured to receive email from the well known email client on a specified TCP/IP port.

36. The method of claim 33 wherein the mail submission agent is a daemon on the email client computer.

37. The method of claim 33 wherein the mail submission agent is embedded in the email client.

38. The method of claim 34 wherein the mail submission agent is configured to receive email from the well known email client on a specified TCP/IP port.

39. The method of claim 34 wherein the mail submission agent is a daemon on the email client computer.

40. The method of claim 34 wherein the mail submission agent is embedded in the email client.

41. The method of claim 38 wherein the mail submission agent is a daemon on the email client computer.

42. The method of claim 38 wherein the mail submission agent is embedded in the email client.
